(19) United States
(12) Patent Application Publication
(10) Pub. No.: US 2006/0060263 A1
(43) Pub. Date: Mar. 23, 2006

(54) Wooden nail-like connector, compressed bamboo material, and method of manufacturing the connector and the material

(76) Inventor: Masafumi Inoue, Chiba (JP)

Correspondence Address: HARNESS, DICKEY & PIERCE, P.L.C., P.O. BOX 8910, RESTON, VA, 20195, US

(21) Appl. No.: 10/545,374

(22) PCT Filed: Aug. 28, 2003
(86) PCT No.: PCT/JP03/10996

§ 371 Date: Aug. 12, 2005

(30) Foreign Application Priority Data
Feb. 13, 2003 (JP) 2003-35636

(51) Int. Cl. B27D 1/00; B27F 7/00; B27G 11/00

(52) U.S. Cl. 144/353

(57) ABSTRACT

A method is disclosed for manufacturing bamboo nails. The method includes horizontally laying down small bamboo plates, obtained by cutting a bamboo piece radially from the center axis thereof, in a press. The small bamboo plates are then pressed perpendicularly to the fibers to produce a compressed flat plate. Finally, the compressed flat plate is cut in the shape of a multangular column. Thus the strength of a wooden material is increased.

### TECHNICAL FIELD

The present invention relates to a wooden nail-like connector (e.g. wooden nail) made of a wooden piece, or a compressed wooden piece (e.g., compressed bamboo piece) obtained by compressing a bamboo piece. The present invention particularly relates to a wooden nail-like connector, and a compressed bamboo piece each having an excellent strength.

### BACKGROUND ART

Conventionally, a metal connector has been mainly used for combining wooden members such as in a house, a piece of furniture, a packing material for use in a transportation, a pallet to be handled by a fork-lift, a bobbin for carrying a wire or the like, or a high class wooden box for use as a gift item. A method for combining the wooden members can be, for example, a method using a coupling member, a dovetail joint, a joint, a nail, a screw, a pin, or a bolt. Recently, excellent adhesive agents are also available. But, in terms of amount being used, an amount of iron nails used is outstandingly large. For example, a total number of approximately 60 thousand nails, staples, and screws are used in the construction of one house. This number even quadruples in a wood frame construction method (two-by-four method).

Meanwhile, a wooden nail is sometimes used for connecting the wooden members. The wooden nail is used only for a specific intended purpose and/or a traditional purpose. This is because characteristics of the wooden nail are utilized which are free from corrosion and defacement of metal, or because a design should be maintained. For Example, wooden nails are used in traditional roofing (kokera-buki (shingled roof), kaya-buki (thatched roof), hiwada-buki (cypress bark roof)), and in the manufacture of a kind of box-like-shaped furniture (e.g., a chest of drawers made of paulownia wood), a gift wooden box (e.g., a wooden box for pickled plums), a coffin, or the like. A material of the wooden nail can be, deutzia wood, Japanese cherry wood, hard maple, bamboo, or the like. For example, such a wooden nail is made of a carved wooden piece to have a shape of stick which is acuminated.

In recent years, recycling and reusing of members has been encouraged, in terms of consideration to the global environment. Under the Japanese Construction Waste Recycling Law, there is an obligation to recycle waste materials, produced during sorting and dismantling of building materials, in a demolition work and/or a construction work, when a scale of the construction or the demolition work reaches or exceeds a certain scale.

However, when iron nails are used as connecting members, like the conventional case, a problem arises in recycling waste materials. More specifically, no problem occurs when the iron nails separated from wooden building materials are sorted by using a magnet or the like. However, if the wooden members which have been connected to each other by using the iron nail are shredded and crushed by a hammer mill or the like, then it is likely that the iron nails remain within the wooden members. It is hazardous to have iron nails remaining within the wooden member. This is because a spark is produced when a blade moving at a high speed touches the remaining iron nail; this spark may start a fire.

Further, since a recycling rate of the wooden members is low, reusing of the wooden members emerges as an alternative for improving the recycling rate. It is however difficult to mechanize the removal of iron nails in the wooden members to be reused. Accordingly, the iron nails are removed manually. This is very costly, and is highly inefficient. Currently, the cost for the removal of the iron nails is causing a setback in the reusing of the wooden members.

As described, the use of iron nails causes a setback in the recycling of the wooden members, and causes significant social and administrative concerns. Under such circumstances, a development of a recyclable wooden connector that can replace the iron nails has been awaited. However, due to a low strength of a conventional wooden nail, it is not very reliable to use the conventional wooden nail in a case of building a house or the like, where a high bonding strength is required. Further, the wooden nail is damaged unless a pilot-hole is provided before the wooden nail is hammered in. Accordingly, it is highly inefficient to use the wooden nail, and it is difficult to employ the wooden nail for use as a connector in an industry.

As a method for improving the strength and surficial physical properties of the wooden piece, a wooden piece compressing method is described in the document (“Compressed Wooden Piece and Vapor Treatment”, vol. 21-4:Functional Pieces, Masafumi INOUE, Takashi HIGASHIHARA, P 67-75, April, 2001.). Further, Japanese Unexamined Patent Publication No. 2001-252907 (Tokukai 2001-252907; Published on Sep. 18, 2001) discloses a method for injecting a chemical into a wooden piece, so that the wooden piece becomes a fire-proof, and that the wooden piece is antisepticised. However, wooden pieces which have been reinforced by these methods have never been industrially used.

Note that the inventors of the present invention have made a brief report on an excellent wooden nail, at an academic conference (The Fourth International Wood Science Symposium) held on Sep. 2, 2002. However, the report did not fully disclose the concrete content of the present invention.

In view of the foregoing problems, the present invention was made, and it is an object of the present invention to manufacture a wooden connector, such as a wooden nail-like connector, whose strength is high, and which can be easily hammered in.

### DISCLOSURE OF INVENTION

A method of the present invention for manufacturing a wooden nail-like connector includes a compressing process for compressing wooden pieces in a direction perpendicular to fibers thereof.

Further, the method is so adapted that, in the compressing process, the wooden pieces are not laminated, but arranged in a planar manner. With the foregoing method, for example, it is possible to obtain a bamboo nail, serving as a wooden nail-like connector, from a single layered compressed bamboo piece. Such a bamboo nail is advantageous, because strength thereof is remarkably high. Here, the description reading “the wooden pieces are not laminated, but arranged in a planar manner” means that the used wooden pieces are not laminated, and are each single layered.

The wooden pieces can be, wood, a bamboo material, a palm material or the like. It is particularly preferable that the wooden pieces be wood having cellulose into which lignin is injected (wood whose cellulose contain lignin so that the cellulose fibers are firmly bonded with each other). In short, it is particularly preferable that the wooden pieces be a material of the lignocellulose family. Further, the description reading “a direction perpendicular to fibers” may be described as a transverse sectional direction perpendicular to axes of the wooden pieces. Each of the wooden pieces is constituted of long and thin tube-like cells. Accordingly, compressing of the wooden piece in the direction perpendicular to the fibers, the cells are squished and compressed. This improves a hardness, an abrasion resistance, and a strength of the wooden piece. Specifically, the improvement of the strength means an increase in a flexural strength, a bending Young's modulus, a resistance against compression, and a buckling strength.

Further, the “wooden nail-like connector” is a nail-like connector made of a wooden piece. For example, such a wooden-nail like connector has, on one of its ends, a sharp angled leading edge. This “nail-like connector” is for fixing and/or connecting two or more wooden pieces with each other. For example, such “nail-like connector” may be a nail, a screw, a bolt, a pin, a driftpin, a dowel, or the like. The nail-like connector may be also described as: (I) a nail-like connector requiring no pilot-hole at the time of using the nail like connector; or (II) a nail-like connector capable of being used with a pilot-hole whose diameter is smaller than an external diameter of the nail-like connector. Further, “nail-like connecters”, such as a nail, a screw, a bolt, a pin, a driftpin, or the like may be described as a nail-like connector being used by providing a targeted object with (I) a pilot-hole whose diameter is smaller than an external diameter of the nail-like connector; or (II) no pilot-hole. Accordingly, these nail-like connectors differ from a dabo which requires a pilot-hole whose diameter is approximately the same as the connector. This means that the nail-like connector of the present invention does not include the connector, such as the dabo, which requires a pilot-hole whose diameter is approximately the same as the connector.

As described, the wooden nail-like connector being manufactured by compressing the wooden pieces has excellent strength. As such, as is the case of a conventional iron nail, such a wooden nail-like connector can be successfully hammered in without damage, even if the wooden nail-like connector is hammered into a targeted object having no pilot-hole. Further, even after the wooden nail-like connector is hammered in, the wooden nail-like connector has characteristics required in nails in general; i.e., a resistance to being pulled out, and a resistance of a jointed portion against shearing. Thus, it is possible to maintain a firm bond. In conclusion, the wooden nail-like connector can be used as a connector in an industry.

Further, the wooden nail-like connector is made of wooden pieces. Accordingly, in a case of disposing of wood having therein the wooden nail-like connector, the wood can be recycled as a material along with the wooden nail-like connector remaining therein. Further, in a case of thermally recycling the wood, the wooden nail-like connector can be also burnt. Further, the wooden nail-like connector as it is can be reused. For example, by using the wooden nail-like connector of the present invention in a house construction, it is possible to recycle waste materials produced in a demolition or a renovation of the house, along with the connector being kept within the wood.

Further, the use of the wooden nail-like connector does not cause a design-related problems such as corrosion or metal defacement. Accordingly, it is possible to avoid a degradation of wooden portions. Further, the wooden nail-like connector realizes a high-class appearance of a product.

Note that a wooden piece having a high strength can be manufactured by adopting bamboo as the wooden material. In other words, the wooden piece is preferably a bamboo piece, and the wooden nail is preferably a bamboo nail. The strength of a connector made of a compressed bamboo piece matches the strength of an iron nail generally used in construction. Strength in a lengthwise direction is particularly needed at the time of hammering in the connector. Accordingly, it is possible to manufacture a firm wooden nail-like connector by using bamboo, having a large amount of fibers in an axial direction, with the wooden nail-like connector being long in a direction of the fibers.

Further, the foregoing method further includes a cutting process for cutting the wooden pieces.

With the method, it is possible to manufacture a connector having a desirable girth from the wooden pieces. The cutting process may be carried out before the wooden pieces are compressed, or after the wooden pieces are compressed. However, the wooden nail-like connector can be efficiently produced by cutting the wooden pieces after the wooden pieces are compressed. Further, by cutting, in the cutting process, the wooden pieces in a direction parallel to the fibers thereof, it is possible to form a wooden nail-like connector which is even more resistant to hammering, and which allows excellent bonding.

Further, the method of the present invention is so adapted that, in the compressing process, the wooden pieces are restrained in a direction perpendicular to the fibers and to the direction of the compression.

When the wooden pieces are being compressed in the direction perpendicular to the direction of the fibers thereof, the wooden pieces tend to stretch in the direction perpendicular to the direction of the fibers and to the direction of the compression. Particularly in the case of wood such as bamboo, whose fibers are weakly bonded in a direction parallel to the fibers, the wood is stretched and is easily damaged.

In view of the foregoing problem, the wooden pieces are restrained as in the foregoing method. This allows the wooden pieces to be compressed, while restraining the wooden pieces from stretching in the direction perpendicular to the direction of the fibers and to the direction of the compression. As a result, damage to the wooden pieces is prevented. Since it is possible to (I) apply a large force for a compression, and (II) manufacture a more densely compressed flat plate, it is possible to manufacture a wooden nail-like connector whose strength is improved. Note that the description “restrained in a direction perpendicular to the fibers and to the direction of the compression” means that a force is generated for preventing the wooden pieces from stretching in the direction perpendicular to the fibers and in the direction of the compression.

The restraining method is for example, a method in which edge portions of the respective wooden pieces are restrained when the compression is carried out in the compressing process. Each of the “edge portions” is a portion at an end of the wooden piece in the direction perpendicular to the fibers and the direction of the compression. More specifically, it is assumed that the wooden piece is sandwiched and compressed in a direction perpendicular to the fibers by using compressing members. The stretching of the wooden piece may be prevented by providing sidewalls to one of the compressing members, the side walls for keeping the edges of the wooden piece within the compressing members.

Further, in the compressing process, the wooden pieces may be held at respective surfaces to be compressed. The “surfaces to be compressed” are surfaces to which a compressing force is applied. More specifically, it is assumed that the wooden piece is sandwiched and compressed in a direction perpendicular to the fibers by using compressing members. An entire surface of a flat plate to be attached to the wooden piece may be provided with a convex-concave pattern. In this way, in the compressing process, due to frictional resistance between the wooden piece and the flat plate, the wooden piece is compressed in the direction perpendicular to the fibers, and does not stretch in the direction perpendicular to the fibers and to the direction of the compression. Note that the convex-concave shape may be formed by using a file or sandpaper for abrading the surfaces. The use of a frictional resistance in restraining the wooden pieces allows any size of wood to be handled.

Further, the foregoing method of the present invention may be so adapted that, during or after the compressing process, a thermal treatment is carried out at a temperature atmosphere of 100° C. or higher, and not higher than 220° C.

It is preferable that a deformation of the wooden pieces be fixed. This is because, after the compressing process is carried out, the wooden pieces recover from the deformation which is caused by the compressing process. In view of this, after the compressing process, a thermal treatment is carried out for fixing the deformation. This allows the deformation caused by the compression to be semi permanently fixed, and allows the reinforcement to be maintained. Further, the deformation caused by compression is successfully fixed by carrying out the thermal treatment for between 1 minute to 20 hours in accordance with a size and type of wood.

Since no chemicals are used in this method, the working environment can be kept clean, and a harmless wooden nail-like connector can be manufactured. Thus, the method is environmentally friendly. Note that the temperature of the foregoing thermal treatment is more preferably 140° C. or higher and not higher than 220° C., and is even more preferably 180° C. and higher and not higher than 220° C.

The compressing process may be carried out after the wooden pieces are impregnated with a resin solution, and the resin solution may be cured during or after the compressing process.

In this way, the cell walls of the wooden pieces are impregnated with a water-soluble resin having a small molecular mass. As such, the compressed flat plate is resinified, thus fixing a compression-caused deformation. Moreover, by impregnating the cell walls with the resin, it is possible to improve resistance to biological degradation, surface hardness, and strength. Note that a method for curing the resin may be selected based on characteristics of the resin. For example, a thermal treatment is selected for a case of using a thermosetting resin, and an exposure to an ultraviolet ray is selected for a case of using an ultraviolet curable resin.

The compressing process may form, on one of the edges of the compressed flat plate, a nail-head portion whose girth is larger than a rest of the compressed flat plate. A wooden nail-like connector manufactured by cutting the foregoing compressed flat plate has, on one of its edges, the nail-head portion whose girth is larger than the rest of the wooden nail-like connector. Accordingly by hammering the wooden nail-like connector so that another edge of the wooden nail-like connector, on the opposite side to the nail head portion, is hammered into an object, the object is held by the nail-head portion of the wooden nail-like connector. Thus, it is possible to realize a wooden nail-like connector which is difficult to pull out.

Further, one of the edges of the wooden connector may be a sharp, angled shape. It only takes a small load to hammer in the wooden nail-like connecter being cut out from the compressed flat plate by hammering the sharp-angled portion of the wooden nail-like connecter, into an object. Note that “one of the edges of the wooden connector may be a sharp, angled shape” means that one of the edges of the compressed flat plate has such a shape that one of angles or angles on both sides are cut off.

Further, it is preferable that the compressing process compress, in a radial direction, small bamboo plates being arranged so that external sides and internal sides of the respective small bamboo plates are alternately face-up, the small bamboo plates being obtained by dividing a bamboo cylinder along dividing lines extending radially from a center of the bamboo cylinder. With the provision of this process, it is possible to efficiently manufacture a bamboo nail by using the bamboo piece. The bamboo piece is cylindrical, and therefore it is difficult to produce compressed flat plate therefrom. However, by dividing the bamboo piece along the parting lines radially extending from the center of the bamboo piece, it is possible to obtain small bamboo plates which are thin in a direction perpendicular to the fibers thereof. By compressing these small bamboo plates while adhering them with one another, a compressed flat plate being compressed in a direction perpendicular to the fibers is obtained. The bamboo nail is simply manufactured by cutting the compressed flat plate into an arbitrary size.

A wooden nail-like connecter which is produced by using the foregoing method is excellent in strength. Further, it is possible to successfully hammer in such a wooden nail-like connector for use in connecting objects.

Further, a wooden nail-like connector of the present invention expands by absorbing moisture.

After the wooden nail-like connector is hammered into an object, the wooden nail-like connector expands within the object, by exposing the wooden nail-like connector to moisture. This causes the connector to be more tightly attached to the object, thus increasing the resistance of the connector to being pulled out. Further, in a case where the wooden nail-like connector is piercing through the object, a portion of the wooden nail-like connector projecting from the object is not compressed by the object. This causes the portion of the wooden nail-like connector to expand. As a result a diameter of the portion becomes larger than a diameter of the hole produced by hammering in the wooden nail-like connector, and the resistance of the wooden nail-like connector to being pulled out is increased. Note that “exposing the wooden nail-like connector to moisture” can be: exposing of the wooden nail-like connector to moisture in the air; application of watery liquid to the wooden nail-like connector; or spraying of high-temperature vapor on the wooden nail-like connector. Further, the wooden nail-like connector further expands by absorbing moisture at a high temperature. Further, expansion means a recovery of the wooden pieces from the deformation caused by compression, or swelling of the wooden pieces caused by the absorption of the moisture.

A method of the present invention, for manufacturing a compressed bamboo pieces, includes a compressing process for compressing bamboo pieces in a direction perpendicular to fibers thereof.

Further, the foregoing method is so adapted that in the compressing process, the bamboo pieces are not laminated but arranged in a planar manner. The compressed bamboo pieces being manufactured by using the foregoing method are compressed bamboo pieces being made of a single layered bamboo pieces. This is advantageous in terms of strength.

The bamboo piece has a higher density than that of other kinds of wood. By compressing such bamboo piece, it is possible to manufacture a compressed bamboo piece whose strength is outstandingly higher than that of a compressed wooden bamboo piece. Further, bamboo is highly renewable, and it is possible to use the bamboo as a material after 3 to 4 years. This allows a large amount of material supply within a short period, at a low cost.

Further, the method is so adapted that the compressing process compresses, in a radial direction, small bamboo plates being arranged so that external sides and internal sides of the respective small bamboo plates are alternately face-up, the small bamboo plates being obtained by dividing a bamboo cylinder along parting lines extending radially from a center of the bamboo cylinder.

Bamboo is cylindrical, and therefore it is difficult to produce compressed flat plates therefrom. However, by dividing the bamboo piece along the parting lines radially extending from the center of the bamboo piece, it is possible to obtain small bamboo plates which are thin in a direction perpendicular to the fibers thereof. By compressing these small bamboo plates while adhering them with one another, a compressed flat plate being compressed in a direction perpendicular to the fibers is obtained.

Further, at the time of compression, the small bamboo plates are so arranged that the respective internal sides and external sides are alternately arranged. This restrains a force, which is generated during the compression, for flattening, in a bending manner, the curvatures of the small bamboo plates. Accordingly, the compression can be carried out without causing the small bamboo plates to crack. Note that the internal side and the external side are respectively an inner skin side and an outer skin side of the bamboo cylinder.

Further, the compressed bamboo piece is a bamboo piece being compressed, and also includes the compressed flat plate being manufactured by using the foregoing methods.

Further, a series of wooden nail-like connectors including a plurality of the wooden nail-like connectors being connected with one another can be used by, for example, loading the series of the wooden nail-like connectors in an automatic nailing machine. This allows a consecutive hammering in of the wooden nail-like connectors. Note that the description reading “being connected with one another” means that the plurality of the wooden nail-like connectors are partially connected with each other. For example, the wooden nail-like connectors can be connected with each other by using paper or plastic. Alternatively, in the manufacturing of the wooden nail-like connectors, it is possible to manufacture the wooden nail-like connectors in a comb-like shape by keeping the wooden nail-like connectors from being completely separated from one another, so that the wooden nail-like connectors are partially connected with one another.

Additional objects, features, and strengths of the present invention will be made clear by the description below. Further, the advantages of the present invention will be evident from the following explanation in reference to the drawings.

### BRIEF DESCRIPTION OF DRAWINGS

FIGS. 1(a) to 1(d) are explanatory diagrams of an embodiment in accordance with the present invention, and illustrate the steps of manufacturing a bamboo nail.

FIG. 2 is a diagram illustrating a relationship between a density and a flexural strength of a compressed flat plate being made of Phyllostachys bambusoides, Phyllostachys heterocycla, or cedar, the compressed flat plate being manufactured by using a method of the present invention for manufacturing a wooden nail-like connector.

FIG. 3(a) is an explanatory diagram illustrating a compression process by using a press platen having grooves, and FIG. 3(b) is an explanatory diagram illustrating a compression process by using a press platen having no grooves.

FIG. 4 is a diagram of an embodiment in accordance with the present invention, and illustrates a bamboo nail having a nail-head, and a compressed flat plate before the bamboo nails have been cut out.

FIG. 5 is a diagram of an embodiment in accordance with the present invention, and illustrates a process of manufacturing a bamboo nail having a nail-head.

FIG. 6 is a diagram illustrating the bamboo nail of an embodiment in accordance with the present invention, the bamboo nail having a nail-head and a sharp leading end having been hammered into cedar.

FIG. 7 is a diagram of the bamboo nail of an embodiment in accordance with the present invention, and illustrates the bamboo nail having been expanded by carrying out a vapor treatment on the bamboo nail, after the bamboo nail had been hammered into a wooden member.

FIG. 8 is a diagram illustrating the bamboo nail of an embodiment in accordance with the present invention, the bamboo nail having been hammered into cedar.

FIG. 9 is a diagram illustrating a relationship between (I) an energy taken for hammering in, by using a drop-type hammering machine, (i) a conventional iron nail, or (ii) the bamboo nail of the embodiment in accordance with the present invention, and (II) an area of the iron nail or the bamboo nail being hammered in.

FIG. 10 is a diagram illustrating a relationship between (I) a load needed for pulling out (i) a conventional iron nail, or (ii) the bamboo nail of an embodiment in accordance with the present invention, and (II) the area of the iron nail or the bamboo nail being pulled out.

### BEST MODE FOR CARRYING OUT THE INVENTION

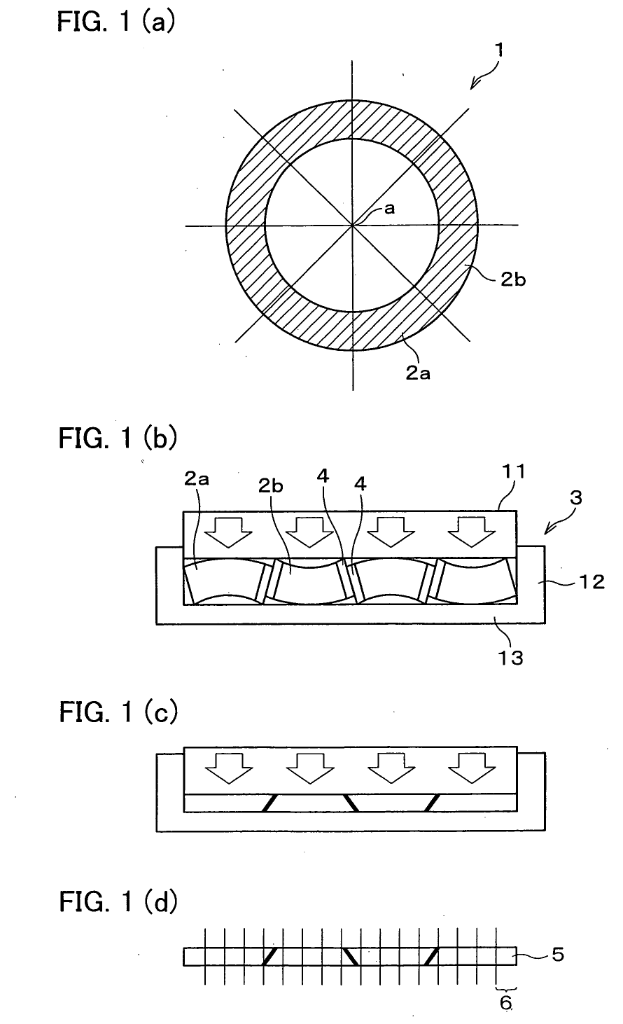

The following describes an embodiment of the present invention with reference to FIGS. 1 to 7. Note that the present embodiment deals with an example in which the present invention is applied to a method for manufacturing a bamboo nail. However, the present invention is not limited to this.

A bamboo piece has a hollow cylindrical shape. It is difficult to (I) make highly efficient use of the bamboo piece as a wooden piece, and (II) obtain, from the bamboo piece, a desirable shape such as a large flat plate. In view of the circumstances, the bamboo cylinder 1 is radially divided into 12 to 16 equal pieces with dividing lines passing through a central axis α, as illustrated in FIG. 1(a), thereby preparing small bamboo plates 2 (2a and 2b) from the bamboo cylinder 1.

These small bamboo plates 2 (2a and 2b) are horizontally arranged. Then, by compressing the small bamboo plates 2 with a press 3, compressed flat plates are obtained. Here, the press 3 is described as follows. The press 3 includes: a bottom plate 13 having two parallel side-walls 12; and a press platen 11 provided parallel to the bottom plate 13. The press platen 11 moves in a direction parallel to the side-walls 12 so as to enter into a box formed by the side-walls. The press platen 11 applies uniform pressure against surfaces of the bamboo plates in an area covered by a surface of the press platen 11, so as to compress the bamboo plates arranged on the bottom plate 13.

As illustrated in FIG. 1(b), the small bamboo plates 2 (2a, 2b) are horizontally bedded in the press 3, while applying an adhesive agent 4 to adjacent end-face portions of the small bamboo plates 2 (note that the adhesive agent is not applied to end-face portions of the outermost small bamboo plates, which do not face an end-face portion of an adjacent small bamboo plate). At this point, the small bamboo plates 2 (2a, 2b) are so arranged that the outer skin and inner skin of the small bamboo plates 2 are alternately face-up. That is, the outer skin side of the small bamboo plate 2a faces up, and the outer skin side of the next small bamboo plate faces down. This allows the end-faces of the adjacent small bamboo plates 2 to be in contact with each other. As mentioned later, any cracking of the small bamboo plates is avoided, by compressing while restraining a bending deformation of the small bamboo plate.

Then, the press 3 is heated to 180° C., and is used to compress the small bamboo plates 2 in a direction (arrowed direction) perpendicular to a direction in which fibers of the small bamboo plates 2 extend. The following describes how the bamboo piece is compressed. Firstly, at an initial stage of the compression, a pressure for the compression is applied to the edge portions of both ends of the inner skin side (i.e., both ends on the upper side of the small bamboo plate 2b), which is in contact with the press 3. This allows the inner skin side to closely contact the press platen 11. Similarly, a curved portion of the outer skin side is compressed, and then closely contacts the bottom plate 13. This allows the curved small bamboo plates 2 to become flat plates. At this point, the adhesive agent, applied to the end-faces of the small bamboo plates 2, adheres the adjacent small bamboo plates 2, so that a continuous flat plate is provided as illustrated in FIG. 1(c).

After the small bamboo plates 2 are flattened, a further pressure is applied to the flat plate. This results in that, firstly, non-dense portions of the bundle sheaths on the respective inner skin sides disappear, and ultimately, gaps between cells disappear. Thus, a compressed flat plate 5 is obtained. Further, during further compression, the side walls 12 restrain the compressed flat plate 5 from further stretching in a sideways direction (a direction parallel to the direction in which the fiber extends). This restraint by the side walls 12 generates a pressing force that causes the small bamboo plates 2 to compress each other. This allows the formation of the compressed flat plate 5 in which the small bamboo plates 2 are closely and strongly adhered to each other. Then, by cutting the compressed flat plate 5 in the shape of a rectangular column, the bamboo nail 6 may be manufactured.

As described, the bending deformation of the small bamboo plates 2 is restrained by compressing while bringing the end-faces of the respective small bamboo plates 2 (2a, 2b) into contact with each other. This prevents the small bamboo plates 2 from being cracked.

If only one small bamboo plate 2 is bedded and compressed, instead of bedding and compressing the plurality of small bamboo plates 2, the edges (end-faces) of the inner skin side of the small bamboo plate 2 are stretched at an initial stage of the compression, and an excessive stress causing the bending deformation is applied to the curvature of the inner skin side. This causes a tension in the small bamboo plate 2, thereby cracking the small bamboo plate 2. In other words, the inner skin side is forcedly stretched if, by the bending deformation, it is attempted to form the small bamboo plate 2 into a flat plate having an identical surface area on both sides of the small bamboo plate 2. As a result, the small bamboo plate 2 is cracked due to the tension thereof. This is because the inner skin side of the curved small bamboo plate 2 has a smaller surface area than that of the outer skin side. This is true in a case where the small bamboo plates 2 are so arranged that the respective inner skin sides face in a same direction. In this case, the adjacent small bamboo plates 2 are in contact with each other in part of the outer skin sides, whereas the inner skin sides are not in contact with each other. Accordingly, as in the case of compressing only one small bamboo plate 2, it is not possible to prevent the bending deformation of the inner skin sides.

On the contrary, in the method of the present embodiment, the small bamboo plates 2 push against each other at the respective adjacent end-faces. This restrains the bending deformation of the respective curvatures, and restrains the sideway stretching of the small bamboo plates 2. Accordingly, the tension is not generated in the small bamboo plates 2. As a result, the small bamboo plates 2 are flattened by compressing the respective convex portions (curvatures on the respective outer skin sides). Thus, it is possible to prevent damage resulting from the compression of the curvatures of the small bamboo plates 2, and yet enable the flattening and consolidation of the small bamboo plates 2. This allows manufacture of a flat, compressed bamboo plate which uses the entire bamboo cylinder 1.

As described, a method of the present invention for manufacturing a wooden nail-like connector (wooden nail, bamboo nail, or the like) may be described as follows. Namely, the method for manufacturing the wooden nail-like connector includes the steps of: (I) dividing a bamboo cylinder, along parting lines radially extending from a center axis of the bamboo cylinder, into small bamboo plates; (II) aligning at least two (or more) of the small bamboo plates obtained in the step I so that (a) edge portions (divided cross sections which are formed by dividing the bamboo cylinder along the parting lines) of the small bamboo plates (wooden pieces) are adjacent to each other, and (b) outer skin sides (long circumferential sections) of the small bamboo plates and inner skin sides (short circumferential sections) of the small bamboo plates are alternately adjacent to each other; and (III) compressing, in a direction parallel to a radial direction, the small bamboo plates thus arranged.

Here, the long circumferential portion is a long arc portion of the small bamboo plate; i.e., the portion on the outer skin side (skin portion of the bamboo cylinder farther from its center axis). On the other hand, the short circumferential portion is a short arc portion of the small bamboo plate; i.e., the portion of the inner skin side (skin portion of the bamboo cylinder closer to the center axis). Further, “a direction parallel to a radial direction”, corresponding to the direction of the compression, means a direction receding from the center axis and/or a direction approaching the center axis.

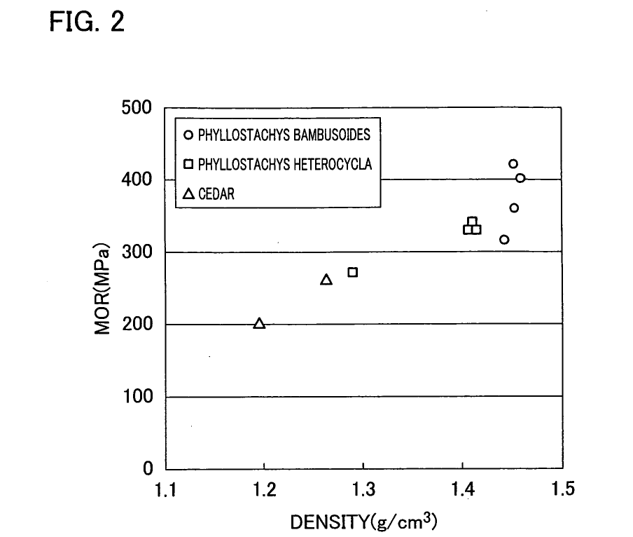

The foregoing compression reduces lumina between the cells of the bamboo pieces, thereby increasing a density of the bamboo pieces. This increases the strength of the bamboo pieces. Here, FIG. 2 indicates flexural strengths of: (A) a bamboo compressed flat plate 5 made of Phyllostachys bambusoides, (B) a bamboo compressed flat plate being manufactured likewise from Phyllostachys heterocycla, and (C) a cedar compressed flat plate which is obtained by cutting out a flat plate, and compressing it using a similar method. The respective flexural strengths were measured according to a measurement method specified by JISZ2113.

From FIG. 2, it is recognized that the flexural strength appears to be correlated with the density, regardless of raw material. In the above case, a highest flexural strength was exhibited by the compressed flat plate of Phyllostachys bambusoides having a highest density. By compressing the Phyllostachys bambusoides at a compressibility ratio of 53% at 180° C., the density of 1.45 g/cm2 and the flexural strength of not less than 400 Mpa were obtained. Further, in some cases, the flexural strength resulted in 500 Mpa at the highest.

Further, in the press 3, the side-walls 12 restrain the sideways stretching (sideways restraint) of the end-face portions of the outermost small bamboo plates 2 which do not face an end face portion of an adjacent small bamboo plate 2. Thus, it is possible to compress the bamboo pieces into flat plates without damage to the curvatures of the respective bamboo pieces caused by compression. Then, the bamboo nail 6 can be manufactured by cutting the consolidated bamboo plate 5 in the shape of a rectangular column (See FIG. 1(d)).

Further, the bamboo piece includes, in a mixed manner, various kinds of tissues (e.g. an outer skin, an inner skin, a bundle sheath, and parenchymatous cells) whose respective densities are different from one another. When compared to a wooden piece, the bamboo piece has fewer tissues in directions in a transverse plane. As such, the tissues of the bamboo piece are weakly bonded in this direction. On this account, when the compression is carried out in a radial direction, the bamboo piece is significantly stretched in a direction along tangential lines, and is easily damaged. However, as described above, this is prevented by (a) arranging the small bamboo plates 2 so that the respective end-faces pushe against each other, and (b) restraining the small bamboo plates 2 by using the side-walls 12.

The compressed flat plates manufactured with or without the sideways restraint were examined. “With the sideways restraint” means that the compression is carried out by using the press 3 having the side-walls 12, and “without the sideways restraint” means that the compression is carried out by using a press 3 having no side-walls 12. The bamboo consolidated plates were significantly destroyed and stretched in the sideways direction in the case of “without the sideways restraint”, whereas the case of “with the sideways restraint” resulted in the bamboo consolidated plates which had been consolidated without any damage thereto.

From this study, it is found that the sideways restraint is essential for significantly deforming the bamboo piece in the sideways direction by compression. Since the bamboo piece is oily and slippery, the sideways restraint is important in the case of compressing the bamboo piece. This sideways restraint may be the foregoing side-walls 12. Alternatively, similar effects are also obtained by using a bottom plate 23 having no side-walls and a press platen 21, each having grooves 91 on the respective surfaces to be in contact with the bamboo piece.

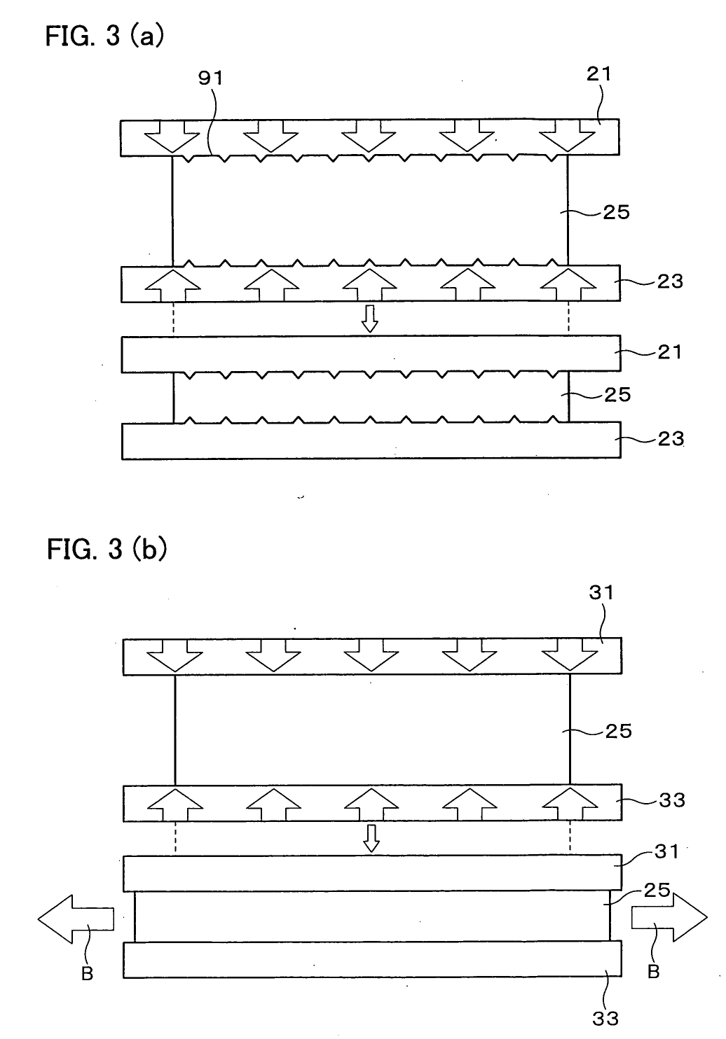

As illustrated in FIG. 3(b) (the upper diagram illustrates a state before the compression, and the lower diagram illustrates a state after the compression), When compressing the bamboo piece 25 by using a press having a bottom plate 33 and a press platen 31 but no sidewalls, the bamboo piece 25 elongates in a direction parallel to the tangential lines (in a direction denoted by the arrows B). In view of this problem, the surface of the press platen 21 and the surface of the bottom surface 13 are arranged with the grooves 91 in a lengthwise direction (the direction of the fibers) of the bamboo piece 25. This increases friction between the bamboo piece 26 and the press platen 21 during the compression, thereby preventing the bamboo piece from stretching in the direction of the tangential lines. As a result, the bamboo piece is compressed without damage.

In the present embodiment, the grooves 91 are arranged on the surfaces of the press platen 21 and the bamboo piece 26. These grooves serve as a convex-concave shape for increasing the friction between the press platen 21 and the bamboo piece 26. However, the convex-concave shape is not limited to the grooves 91 and the convex-concave shape may be formed by using a file or sandpaper for abrading the surfaces. The use of a frictional resistance in the sideways restraint allows any size of wooden piece to be handled by the press.

The bamboo piece thus compressed recovers from its deformation, after leaving the bamboo piece alone for a long period. More specifically, when the wooden piece is pressed at a high temperature, the deformation of the wooden piece is temporarily set (drying-set), due to hydrogen bonding amongst constituents of the wooden piece. This deformation of the wooden piece is maintained in a relatively stable manner under dry conditions. However, with effects of moisture and heat, cell walls of the wooden piece expand and recover from the deformation, thereby substantially restoring the shape of the wooden piece before the deformation.

When the compressed bamboo piece is used as a nail, however, the deformation is maintained after the nail is hammered in, due to a constantly applied pressure around the nail. Note that the bamboo nail 6 has a necessary dimension stability. That is, the deformation of the bamboo nail 6 caused by compression is stable while the bamboo nail 6 is being stored, and while the bamboo nail 6 is being handled at the time of being hammered in.

Further, the bamboo nail 6 has an adequate strength in the lengthwise direction thereof, and it was possible to hammer the bamboo nail 6 into a wooden member. It was also possible to hammer the bamboo nail 6 into cedar by using an automatic nailing machine, even though a pilot-hole was not provided. The bamboo nails 6 can be consecutively hammered in by loading the automatic nailing machine with a stick-type series of bamboo nails 6 (a comb-like shaped series of bamboo nails being manufactured as a single piece), or a coil-type series of bamboo nails 6 (individually manufactured bamboo nails being connected by using plastic or paper). Further, even after the bamboo nail 6 is hammered in, the bamboo nail 6 exhibited an adequate maintaining capability for holding a joint together and a horizontal-shearing resistance. Moreover, the bamboo nail 6 is adequately resistant against biological degradation; i.e., resistance against decay, fungi and termites. Thus, the bamboo nail 6 allows a structure whose members are stably joined with each other for a long period.

Additionally, a cost of the bamboo piece for use in the bamboo nail 6 is affordable, and it is sufficiently feasible to process the bamboo piece that has been compressed in a secondary process or in a cutting process. In conclusion, the bamboo nail 6 is more advantageous in terms of manufacturing cost than a conventional iron nail.

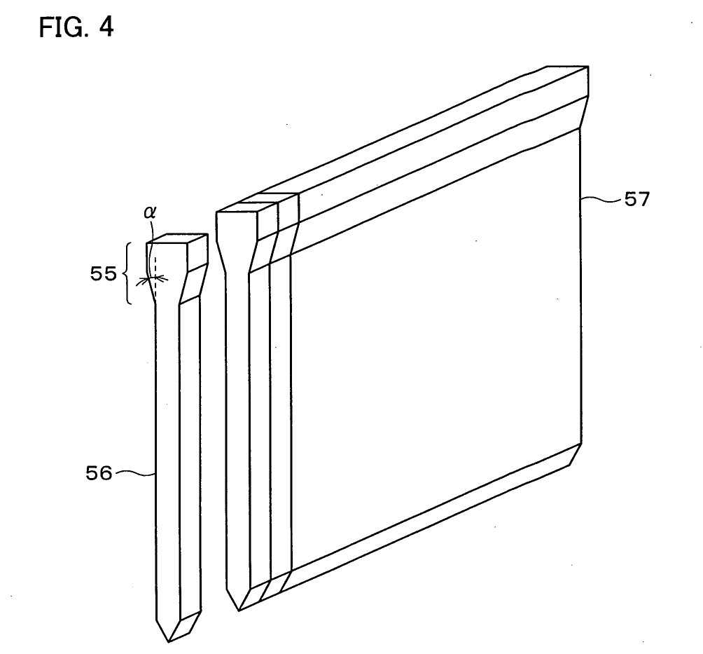

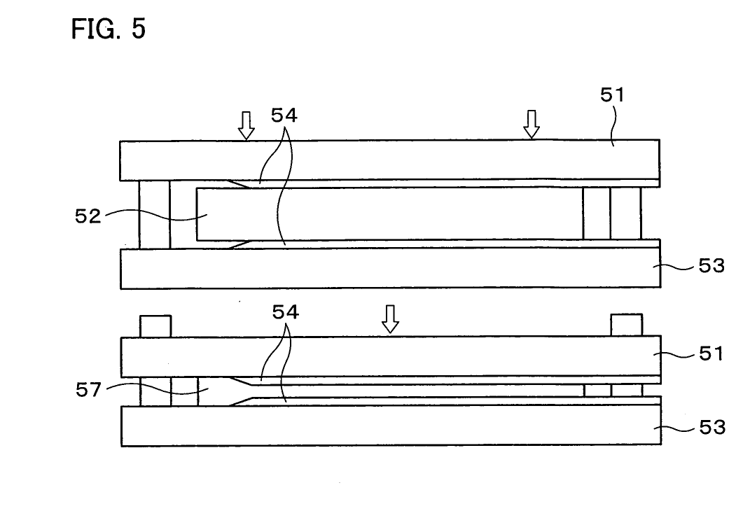

The straight-type bamboo nail 6 thus manufactured can be used in finishing of an interior or the like. Meanwhile, in a case where, for example, the bamboo nail 6 is used as a connector for a structural wall or the like, a resistance of the bamboo nail 6 to being pulled out needs to be increased. In such a case, the bamboo nail 56 may be provided with a nail-head 55 as illustrated in FIG. 4. such a nail-head 55 can be realized as follows. Namely, when compressing a bamboo plate 52 by using the press 3, the bamboo plate 52 is so compressed that the bamboo plate 52 has, on an edge portion thereof, a section whose thickness gradually increases, as is the case of the bamboo plate 57. In other words, as shown in FIG. 5, one of the edge portions of the bamboo plate 52 is less compressed than others by using a die 54 having, on one edge, an inclined surface between a press platen 51 and the bamboo plate 52, and between a bottom plate 53 and the bamboo plate 52. This forms the compressed flat plate 57 having a section corresponding to the nail-head that is thicker than the rest of the bamboo plate 57. Incidentally, the nail-head becomes larger on the internal sheath side. This is because the bamboo piece is more easily deformed on its internal sheath side than it is on its external sheath side. This however is not cause of concern, since the pull-out resistance is supported by the internal sheath side of the nail-head. By cutting this compressed flat plate 57 in the shape of a rectangular column, bamboo nail 56 having a nail-head is manufactured. The inclination α (a sharp angle formed between the head section and an extended line of the body section) from a body section of the bamboo nail 56 illustrated in FIG. 4 to a head section of the same is preferably 30 degree or less. In short, the declination of the die 54 is preferably 30 degree or less.

Further, in order to sharpen another edge portion of the bamboo nail, a sharp angle may be formed on the other end of the compressed flat plate. By hammering the sharp-angled portion of the wooden nail-like connecter into an object, it only takes a small load to hammer in the wooden nail-like connecter that is cut out of the compressed flat plate. Note that the sharp edge portion of the compressed flat plate may be formed by using a platen for sharpening the edge portion at the time of carrying out the compression. Alternatively, the sharp edge portion may be sharpened by carrying out a cutting process with respect to the surface of the edge portion.

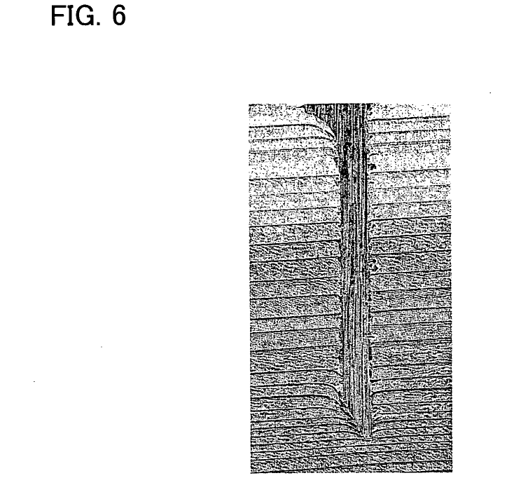

The bamboo nail 6 having the nail-head 55 and the sharp-angled portion on the other end was successfully hammered into cedar as shown in FIG. 6.

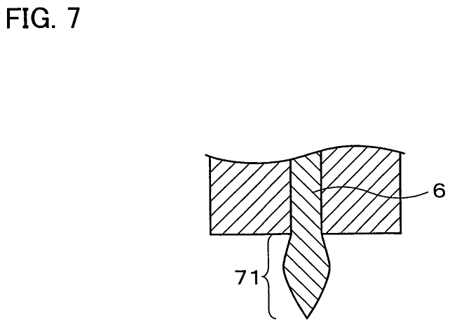

Further, it is possible to increase the resistance of the bamboo nail 6 to being pulled out by utilizing the aforementioned characteristic of recovering from the deformation. In other words, the bamboo nail 6 having been hammered in may be steamed, so that the bamboo nail is expanded, thus causing the pull-out resistance to increase. More specifically, when the bamboo nail 6, which has been hammered into a wooden member, is steamed, the bamboo nail 6 recovers from its deformation due to the effects of the heat and moisture. This causes the portion of the bamboo nail 6 penetrating the wooden member to be more tightly attached to the wooden member surrounding the bamboo nail 6. As a result, the bamboo nail is hardly pulled out at the time of shearing. Further, as illustrated in FIG. 7, the leading edge 71 of the bamboo nail 6 projecting from a back side of the wooden member expands, because the leading edge 71 is free of pressure applied by the wooden member. This results in a similar effect as clinching, and the pull-out resistance increases as such.

Further, by carrying out a resin-treatment or a thermal-treatment with respect to the bamboo nail of the present invention, it is possible to stabilize (dimension stabilization) the recovery of the bamboo nail from the deformation.

First described is the resin-treatment. In the manufacture of the bamboo nail 6, the bamboo piece is dried prior to the compression. The bamboo piece is then dipped into low molecular weight phenol resin, and is dried off. After that, the resin is cured by carrying out the aforementioned heated compression. This realizes a compressed bamboo piece whose dimension is highly stable. Further, the flexural strength and a surface hardness of the bamboo piece is remarkably improved, and the bamboo piece even has resistance against biological degradation.

The resin which is used is not particularly limited, provided that the resin is water-soluble and infiltrative, and that a molecular mass of the resin is small. It is however preferable that the molecular mass of the resin be between 200 to 600, and that a percentage of a solid content in the resin is 5 to 30%. For example, the resin to be used can be melamine resin, glyoxal resin, or the like. It is further preferable that the resin be phenol resin.

Next described is the thermal treatment. In the manufacture of the bamboo nail 6, after the compression is carried out, the thermal treatment is carried out on the compression flat plate, at a temperature of 100° C. or higher but not higher than 220° C. This allows a semi-permanent setting of the deformation, thus retaining the conditions having been reinforced by the compression.

Since a chemical is not used in this method, the working environment can be kept clean, and a harmless wooden nail-like connector can be manufactured. Thus, the method is environmentally friendly. Note that the temperature of the foregoing thermal treatment is more preferably 140° C. or higher and not higher than 220° C., and is even more preferably 180° C. or higher and not higher than 220° C.

The thermal treatment is carried out by using a hot-press using a pressing machine having a heated platen that is heated up to 100 to 220° C., preferably up to 180 to 220° C. With this hot-press, the thermal treatment is carried out for 5 to 20 hours, on the wooden piece with its deformation being maintained. This permanently sets the deformation of the wooden piece caused by compression. Note that the thermal treatment may be carried out by retaining the wooden piece in the hot-press machine, or by placing the wooden piece in a high temperature oven, with its deformation caused by compression being temporarily maintained.

Alternatively, the thermal treatment may be a method in which a water-vapor treatment is carried out. More specifically, in the method, the wooden piece is compressed, in a pressure tight case having therein a press machine, for a few minutes by supplying high-pressure water vapor (1 to 1.6 MPa) at a temperature of between 180 and 200° C. As in the foregoing method, the water-vapor treatment may be carried out with the deformation of the wooden piece being maintained by a jig, the deformation of the wooden piece being caused by the compression having been previously carried out.

A difference between the foregoing treatments is a water-content of the wooden piece during the period of heating. Being aware of this fact, it is possible to use a simple technology for setting deformation, such as a closed vessel heating treatment and a high-frequency induction heating treatment.

By carrying out the thermal treatment as described above, the dimension stability of the wooden piece and the resistance against biological degradation are improved.

The present embodiment deals with a case where the present invention is applied to a method for manufacturing the wooden nail from a bamboo piece. However, the present invention is not limited to this, and it is possible to apply the present invention to (I) a method for manufacturing a compressed flat plate by compressing a bamboo piece, as well as (II) a method for manufacturing a compressed material of various kinds of wood.

Further, in this embodiment of the present invention, Phyllostachys bambusoides was used as a wooden piece. However, the wooden piece is not limited to this. For example, it is possible to manufacture a wooden nail by using: a bamboo piece such as Phyllostachys heterocycle and Phyllostachys nigra; or a wooden piece such as cedar.

Further, in the present embodiment, a pressing-type compression was carried out. However, it is possible to carry out a rolling-type compression.

Incidentally, as in the present embodiment, if (i) bamboo is used as a wooden piece; and (ii) the bamboo is cut in a lengthwise direction, the obtained small bamboo plates respectively have cross-sectional surfaces in a trapezoidal shape. These small bamboo plates could not be compressed as they were. In view of this problem, end portions of the small bamboo plates were cut so that the trapezoidal cross-sectional surfaces become rectangular cross-sectional surfaces. This however is inefficient, because a half or more of the bamboo is wasted.

On the contrary, in the present invention, the small bamboo plates are arranged so that (I) external sheath sides and the internal sheath sides of the respective small bamboo plates are alternately arranged, and (II) the respective trapezoidal cross-sectional surfaces are alternately arranged. This causes friction between the small bamboo plates, thus enabling a compression by using a high pressure even if the sideways restraint is not provided. Needless to say that, this technology is also applicable to a wooden piece other than bamboo.

Further, a technology of compressing wooden pieces has been developed since the 1930s. However, it was not possible to compress a wooden piece with a pressure higher than approximately 200 MPa. However, with the technology of the present invention, it is possible to apply a pressure of 400 to 450 MPa. This allows the manufacture of very solid compressed wooden pieces (e.g., compressed bamboo pieces). The compressed wooden piece thus obtained can be used as a wooden nail-like connector, such as a nail.

Further, the present invention allows the manufacture of not only a single-layered wooden piece, but also a multi-layered wooden piece. Particularly, a connector having a large diameter or a wooden piece therefor can be manufactured by laminating a plurality of single-layered wooden plates.

Further, the compressed wooden piece (e.g., compressed bamboo piece), the wooden nail-like connector, or the like being manufactured according to the present invention can be used in a framework or the like in a tanker. For example, a tanker which contains LPG or LNG has therein a smaller tank which is fixed by using a wooden frame. A temperature of LNG or the like during its liquid phase is below minus one hundred and several tens ° C. On this account, the fixing member for the tank containing such LNG or the like is preferably a wooden frame. This is because the wooden frame does not cause dew formation due to its insulative characteristic. However, if a metallic nail or the like is used in fixing the wooden frame, dew formation occurs on the nail. This may cause the wooden frame to rot. Such a problem however is avoidable by using the wooden nail-like connector of the present invention.

Further, the compressed wooden piece (e.g., compressed bamboo piece), the wooden nail-like connector, or the like being manufactured according to the present invention can be used for fixing an insulation material to be provided inside a wall of a house. The insulation material is usually fixed by a nail or the like. However, the use of a metallic nail causes heat to escape therefrom. Thus, the insulation effect is deteriorated. This problem however is avoided by using the wooden nail-like connector of the present invention.

Note that the description of the present embodiment deals mainly with a wooden nail-like connector. However, the present invention is also applicable for a non-nail-like wooden connector. In other words, the present invention may include a method for manufacturing a wooden connector, the method including the step of compressing a wooden piece in a direction perpendicular to a direction of fiber of the wooden piece. Further, the present invention includes the wooden connector manufactured by the foregoing method of manufacturing the wooden connector.

Further, “wooden connector” means a connector made from a wooden piece. The “connector” is for fixing and/or connecting two wooden members with each other. For example, such “connector” may be a nail, a screw, a bolt, a pin, a driftpin, a dabo, or the like. The above listed wooden connectors will result in the same effects as those obtained from the wooden nail-like connector described in this specification. Needless to mention that the explanation of the present embodiment dealing with the case of wooden nail-like connector is entirely applicable to the other wooden connectors.

Further, the present invention includes a method for manufacturing a compressed wooden piece, the method including the step of compressing a bamboo piece in a direction perpendicular to a direction of fibers of the bamboo piece. Further, the present invention includes the compressed wooden piece manufactured by the foregoing method of manufacturing a compressed wooden piece. The compressed wooden piece will result in the same effects as those obtained from the compressed wooden piece described in this specification. Needless to mention that the explanation of the present embodiment dealing with the case of the compressed wooden piece is entirely applicable for the wooden connectors.

### EXAMPLE

[Hammering Test for Non-Compressed Bamboo Nail (Comparative Experiment)]

A 4 mm rectangular column was cut out from an unprocessed bamboo piece, and from this rectangular column, bamboo nails were made by forming a nail-point shape (diamond point) through a cutting process. The bamboo nails were then hammered into cedar without pilot-holes being perforated beforehand. The bamboo nails were either 50 mm or 90 mm in length.

As a result; it was possible to hammer in some of the rectangular columns of 50 mm in length, the rectangular column being cut out from the external sheath side whose strength is high. Many of the bamboo nails however were damaged due to an impact in a lengthwise direction, and were cracked in a direction of their fiber. Further, with the bamboo nails of 90 mm in length, typical buckling failure was observed at center portions of the respective bamboo nails, when the bamboo nail was hammered into the cedar material by 30 mm. As a result, all of the nails were broken.

In conclusion, it is found that the bamboo nails cut out from the unprocessed bamboo piece do not have a strength which is sufficient for use in an industry.

[Hammering-In Test by Using an Automatic Nailing Machine]

Next, a flat plate was prepared by carrying out the method of the present invention for consolidating Phyllostachys bambusoides of 6 to 8 mm in thickness at 180° C. and 30 MPa. From this flat plate, rectangular columns of 2.5 mm to 4.5 mm were cut out, and bamboo nails of 5 to 9 cm in length were manufactured from these rectangular columns. Each of the bamboo nails had a diamond point of 60 degree on one of its ends.

The bamboo nails thus formed were subjected to a hammering-in test by using an automatic nailing machine (HN-50 and CN890S manufactured by MAX. Co. Ltd.). Materials, into which the bamboo nails were hammered, were cedar, larch, spruce wood, and laminated wood of these materials.

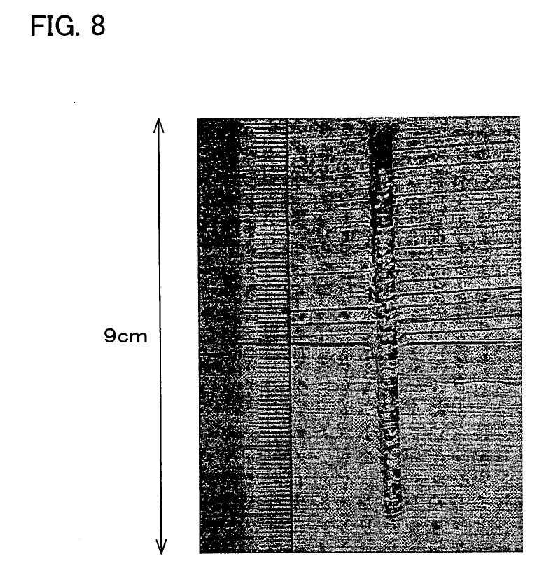

As a result, the bamboo nails were successfully hammered into all of the materials; i.e., the cedar, larch, spruce wood, and laminated wood. FIG. 8 illustrates the 9 cm bamboo nail of the present example being hammered into the cedar. Damage to the leading edge of the bamboo nail was not observed, and fiber cut off due to the hammering of the bamboo nail adhered to surfaces of the bamboo nail.

[Hammering Test by Using Drop-Type Hammering Machine]

Next a drop-type hammering machine was used, and a study was conducted on a relationship between an energy needed for hammering the bamboo nail, and an area of the bamboo nail hammered in. The drop-type hammering machine is an apparatus having a plummet whose gravity is variable. This drop-type hammering machine hammers a nail by using the gravity of the plummet. The plummet freely falls along a rail of 2.5 m in length, and hits a driver whose bottom section is provided with a bamboo nail being so placed that the leading end of the bamboo nail is hammered in. Note that in the test, bamboo nails were hammered into cedar. The weight of the plummet was varied within a range between 0.5 kg and 5 kg, in increments of 0.5 kg. With this apparatus, the driver can be hit at approximately 5 to 250 Nm.

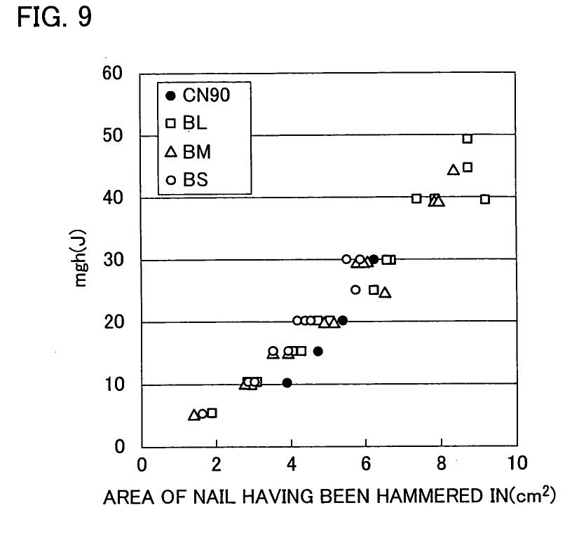

Results are shown in FIG. 9. The longitudinal axis represents an energy of the plummet hitting the driver, and the horizontal axis represents an area of the bamboo nail having been hammered in; i.e., a surface area of a portion of the bamboo nail having been hammered in. Four kinds of nails were used in this test. These nails were: CN90(●) which is a nail in compliance with 90 mm-nail standard for two-by-four method; a bamboo nail (BL, □) of the present embodiment whose body is 4.0 mm in width; a bamboo nail (BM, Δ) of the present embodiment whose body is 3.4 mm in width; and a bamboo nail (BS, ◯) of the present embodiment whose body is 2.7 mm in width.

From this test, it is found that all of the bamboo nails of the present invention can be hammered in as in the case of hammering in the conventional CN 90 nails. Further, while the energy needed for the hammering in the CN nail exponentially increased with respect to the amount of the CN nail being hammered in, the increase in the energy needed for hammering the bamboo nail was substantially linear regardless of the girth of the bamboo nail.

[Pull-Out Test]

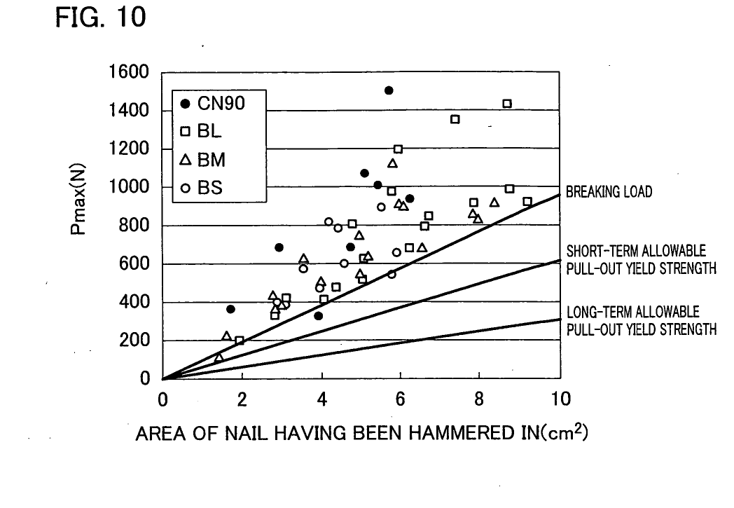

As in the foregoing test, a study on resistance against a pulling-out process was carried out with respect to the CN90 nails and the bamboo nails of the present invention. FIG. 10 shows a relationship between a maximum load for pulling nails, and the nailing area. As in the foregoing test, 4 kinds of nails were used in this test. These nails were: CN90(●); the bamboo nail (BL, □) of the present embodiment whose body is 4.0 mm in width; the bamboo nail (BM, Δ) of the present embodiment whose body is 3.4 mm in width; and the bamboo nail (BS, ◯) of the present embodiment whose body is 2.7 mm in width. Note that CN 90 was subjected to a surface process (coating process) for increasing the pull-out resistance.

In FIG. 10, the vertical axis represents the maximum load for pulling out the nail, and the horizontal axis represents an area in which the nail is hammered in. From this test, it is found that all of the bamboo nails had pull-out resistances matching that of the CN90.

Meanwhile, an allowable pull-out yield strength being generally required in a nail was calculated. This allowable pull-out yield strength is a limit of pull-out load, at which a nail is not pulled-out. The allowable pull-out yield strength was compared with the pull-out resistance of the nails of the present embodiment. As a result, the bamboo nails exhibited a pull-out yield strength which is higher than the allowable pull-out yield strength (See FIG. 10). Accordingly, the bamboo nails of the present invention sufficiently satisfy a design standard. Here, a long-term allowable pull-out yield strength is a pull-out yield strength for a load being applied for a long period, and a short-term allowable pull-out yield strength is a pull-out yield strength for a load being instantaneously applied. Further, the pull-out yield strength was larger than a typical breaking load (a maximum load that does not damage the nail) being required for pulling out a nail (See FIG. 10).

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

As described, a method of the present invention for manufacturing a wooden nail-like connector includes a compressing step for forming a compressed flat plate by compressing a wooden material in a direction perpendicular to a direction of a fiber of the wooden material.

With this method, it is possible to provide a wooden connector having sufficient strength for functioning as a connector.

A use of the wooden nail-like connector in connecting wooden materials has the following advantages, in terms of recycling the wooden material. 1. in a case of recycling as a material, it is not necessary to separate the connector from the rest of the wooden materials, and no fire starting sparks are produced in a crushing process. Further, in a case of thermal recycling, the connector can be burned with the rest of the wooden material, at the same time.

2. In a case of reusing the wooden material and the connector, it is possible to cut the wooden material and the nail by using a woodworking tool, even if the nail remains in the wooden material. Accordingly, the wooden material having the nail therein can be reused together with the nail.

3. While the connector is used, the connector does not cause design-related problems, such as corrosion or metal defacement. Further, it is possible to avoid a degradation of the wooden material, caused by dew formation. Further, it realizes a high-class appearance of a product.

Further, by using a bamboo piece as the foregoing wooden piece, it is possible to manufacture a wooden nail-like connector having a higher density and a higher strength. This is also advantageous in terms of cost, because the bamboo material is easy to process, and is low in cost.

1. A method for manufacturing a wooden nail-like connector comprising a compressing process for compressing wooden pieces in a direction perpendicular to fibers thereof.

2. The method as set forth in claim 1, wherein:
in the compressing process, the wooden pieces are not laminated but arranged in a planar manner.

3. The method as set forth in claim, wherein:
the wooden pieces are bamboo pieces; and the wooden nail-like connector is a bamboo nail.

4. The method as set forth in claim 1, further comprising a cutting process for cutting the wooden pieces.

5. The method as set forth in claim 1, wherein:
in the compressing process, the wooden pieces are restrained in a direction perpendicular to the fibers and the direction of the compression.

6. The method as set forth in claim 5, wherein:
in the compressing process, the wooden pieces are restrained at their edge-portions.

7. The method as set forth in claim 5, wherein: in the compressing process, the wooden pieces are held at respective surfaces to be compressed.

8. The method as set forth in claim 1, wherein:
during or after the compressing process, a thermal treatment is carried out at a temperature atmosphere of 100° C. or higher and not higher than 220° C.

9. The method as set forth in claim 1, wherein:
the compressing process is carried out after the wooden pieces are impregnated with a resin solution; and
the resin solution is cured during or after the compressing process.

10. The method as set forth in claim 1, wherein:
the compressing process forms, on one of edges of the compressed flat plate, a nail-head portion whose girth is larger than a rest of the compressed flat plate.

11. The method as set forth in claim 1, wherein one of the edges of the wooden nail-like connector is a sharp angled shape.

12. The method as set forth in claim 1, wherein:
the compressing process compresses, in a radial direction, small bamboo plates being arranged so that external sides and internal sides of the respective small bamboo plates are alternately face-up, the small bamboo plates being obtained by dividing a bamboo cylinder along a dividing line extending in a radial direction from a center of the bamboo cylinder.

13. A method for manufacturing a compressed bamboo piece, comprising a compressing process for compressing bamboo pieces in a direction perpendicular to fibers thereof.

14. The method as set forth in claim 13, wherein:
in the compressing process, the bamboo pieces are not laminated but arranged in a planar manner.

15. The method as set forth in claim 13, wherein:
the compressing process compresses, in a radial direction, small bamboo plates being arranged so that external sides and internal sides of the respective small bamboo plates are alternately face-up, the small bamboo plates being obtained by dividing a bamboo cylinder along a dividing line extending in radial direction from a center of the bamboo cylinder.

16. A wooden nail-like connector being manufactured by using the method as set forth in claim 1.

17. A wooden nail-like connector wherein:
the wooden nail-like connector is manufactured by compressing a wooden piece in a direction perpendicular to fibers thereof; and
the wooden nail-like connector expands by absorbing moisture.

18. A compressed bamboo piece being manufactured by using the method as set forth in claim 13.

19. A series of wooden nail-like connectors comprising a plurality of the wooden nail-like connectors as set forth in claim 16, the plurality of the wooden nail-like connectors being connected with one another.
